(19) United States
(12) Patent Application Publication
(10) Pub. No.: US 2013/0141306 A1
(43) Pub. Date: Jun. 6, 2013

(54) MIXED ANTENNA SYSTEM DRIVING METHOD

(71) Applicants: Chiu-Lin CHIANG, Taipei City (TW); Chang-Ching LIN, Taipei City (TW); Wei-Lun LIN, Taipei City (TW)

(72) Inventors: Chiu-Lin CHIANG, Taipei City (TW); Chang-Ching LIN, Taipei City (TW); Wei-Lun LIN, Taipei City (TW)

(21) Appl. No.: 13/309,315

(22) Filed: Dec. 1, 2011

(51) Int. Cl. H01Q 1/00

(52) U.S. Cl. 343/904

(57) ABSTRACT

A mixed antenna system driving method for driving a mixed antenna consisting of a control IC, a sensor module and an antenna is disclosed. The control IC switches the antenna to a capacitive proximity sensor of the sensor module for enabling the capacitive proximity sensor to sense the approaching of an external object by means of the antenna, and then switches the antenna away from the capacitive proximity sensor to an electromagnetic wave generating circuit of the sensor module for enabling the electromagnetic wave generating circuit to perform an induction operation by means of the antenna after received a sensed signal from the capacitive proximity sensor, and switches the antenna back to the capacitive proximity sensor after the induction operation of the electromagnetic wave generating circuit.

### BACKGROUND OF THE INVENTION

1. Field of the Invention

The present invention relates to antenna technology and more particularly, to a mixed antenna system driving method, which allows the capacitive proximity sensor and electromagnetic wave generating circuit of a sensor module to share a common antenna, saving electric energy and reducing heat.

2. Description of the Related Art

Following fast development of wireless technology, wireless application related products have been continuously developed to facilitate people, save time and secure home safety. Wireless technology can also be employed in a wide variety of security applications. For example, RFID (radio frequency identification) has been intensively used for home security application, value-added services, and industrial inventory control.

In inventory management, a posterior circuit is electrically connected to an antenna that may be configured in the form of a door or flat plate and installed at the exit for fetching data from a RFID tag on each product carried on a truck. Subject to the application of cloud technology, the fetched data signal is transmitted to a processing system for automatic computing, achieving inventory control and management.

In the aforesaid RFID application example, the antenna is controlled by the posterior circuit to emit electromagnetic waves subject to a predetermined time interval for fetching data signal from RFID tags. Even during the time where no RFID tag appears in the sensing range, the antenna keeps emitting electromagnetic waves subject to the control of the posterior circuit. This operating mode consumes much electric energy and produces much waste heat. To avoid this problem, infrared or capacitive induction technology may be employed to detect the approaching of products and to control starting of RFID induction only after detection of the approach of products.

Either the optical infrared induction or the capacitive induction, an extra loop and circuit space are required. For example, the application of the capacitive induction technology requires much installation space for the two antennae. The antenna for capacitive induction and the antenna for RFID induction may be designed in the form of an eddy pattern to save the installation space. However, these two antennae may cause interference to each other. If one antenna is driven to work and the other antenna is switched off and grounded, the latter may become a barrier which narrows the range of induction of the former. If one antenna is driven to work and the other antenna is switched off and floating, the later may become the target of the former and assimilated, causing change or destruction of the field pattern and matching. A change in matching between the antenna and the posterior circuit would reduce the performance in electromagnetic wave energy conversion. In this case, the signal strength is lowered and the transmission distance is shortened while energy consumption remains unchanged.

Thus, the aforesaid conventional RFID applications have drawbacks as follows:
1. No matter there is any RFID tag within the sensing range, the antenna keeps emitting electromagnetic waves, wasting much power and producing much waste heat.
2. When a RFID induction device and an infrared or capacitive induction device are used together, two separate antennae must be used and are respectively electrically connected to the RFID induction device and the infrared or capacitive induction device, increasing the cost and requiring much installation space.
3. If an antenna for capacitive induction and an antenna for RFID induction are arranged close to each other and kept apart, the two antennae may cause interference to each other; if one antenna is driven to work and the other antenna is switched off and grounded or floating, the latter antenna forms a barrier which narrows the range of induction of the former, or becomes the target of the former and assimilated, causing change or destruction of the field pattern and matching and lower the signal strength or shorten the transmission distance.

Therefore, it is desirable to provide a mixed antenna for RFID application, which eliminates the problems of the aforesaid prior art designs.

### SUMMARY OF THE INVENTION

The present invention has been accomplished under the circumstances in view. An object of the present invention is to provide a mixed antenna system driving method, which allows a capacitive proximity sensor and an electromagnetic wave generating circuit to share a common antenna, saving energy consumption, installation space and cost.

To achieve this and other objects of the present invention, a mixed antenna system driving method is adapted for driving a mixed antenna system which comprises an antenna, a control IC electrically connected to an external processing system, and a sensor module, which comprises a capacitive proximity sensor and an electromagnetic wave generating circuit selectively connectable to the antenna subject to the control of the control IC. The control IC controls switching the antenna between the RF mode for the electromagnetic wave generating circuit and the capacitive mode for the capacitive proximity sensor of the sensor module, enabling the capacitive proximity sensor of the sensor module to sense the approach of an external object via the antenna and then enabling the electromagnetic wave generating circuit to start induction operation via the antenna after detection of the presence of the external object by the capacitive proximity sensor, i.e., the capacitive proximity sensor performs a long period sensing work with less power consumption and less waste heat production and, the electromagnetic wave generating circuit is controlled to start working only upon approach of an external object. Thus, under the same effects of use, the mixed antenna system saves much power consumption and produces less waste heat, achieving the targets of energy-saving and carbon-reduction.

Further, the control IC controls selective connection between the antenna and the electromagnetic wave generating circuit or the capacitive proximity sensor, and the capacitive proximity sensor and the electromagnetic wave generating circuit share the common antenna, saving product cost and installation space.

Further, the capacitive proximity sensor and the electromagnetic wave generating circuit are alternatively connected to the common antenna, avoiding antenna interference, destruction in antenna radiation pattern or matching change, assuring a high performance in capacitive induction or RF induction, and eliminating unnecessary adjustment or maintenance works.

Further, by means of modifying the posterior circuits, the invention is applicable to any conventional RF type induction system without changing all the components, and therefore the invention can save much the equipment cost.

### BRIEF DESCRIPTION OF THE DRAWINGS

FIG. 1 is a system block diagram of a mixed antenna system in accordance with a first embodiment of the present invention.

FIG. 2 is a circuit diagram of the mixed antenna system shown in FIG. 1.

FIG. 2A is an enlarged view of part 2A of FIG. 2.

FIG. 2B is an enlarged view of part 2B of FIG. 2.

FIG. 2C is an enlarged view of part 2C of FIG. 2.

FIG. 2D is an enlarged view of part 2D of FIG. 2.

FIG. 2E is a schematic assembly view of FIGS. 2A-2D.

FIG. 3 is an operation flow chart of the first embodiment of the present invention.

FIG. 4 is a system block diagram of the mixed antenna system in accordance with a second embodiment of the present invention.

FIG. 5 is a circuit diagram of the mixed antenna system shown in FIG. 4.

FIG. 5A is an enlarged view of part 5A of FIG. 5.

FIG. 5B is an enlarged view of part 5B of FIG. 5.

FIG. 5C is an enlarged view of part 5C of FIG. 5.

FIG. 5D is an enlarged view of part 5D of FIG. 5.

FIG. 5E is an enlarged view of part 5E of FIG. 5.

FIG. 5F is a schematic assembly view of FIGS. 5A-5D.

FIG. 6 is a system block diagram of the mixed antenna system in accordance with a third embodiment of the present invention.

FIG. 7 is a circuit diagram of the mixed antenna system shown in FIG. 6.

FIG. 7A is an enlarged view of part 7A of FIG. 7.

FIG. 7B is an enlarged view of part 7B of FIG. 7.

FIG. 7C is an enlarged view of part 7C of FIG. 7.

FIG. 7D is an enlarged view of part 7D of FIG. 7.

FIG. 7E is an enlarged view of part 7E of FIG. 7.

FIG. 7F is a schematic assembly view of FIGS. 7A-7E.

### DETAILED DESCRIPTION OF THE PREFERRED EMBODIMENT

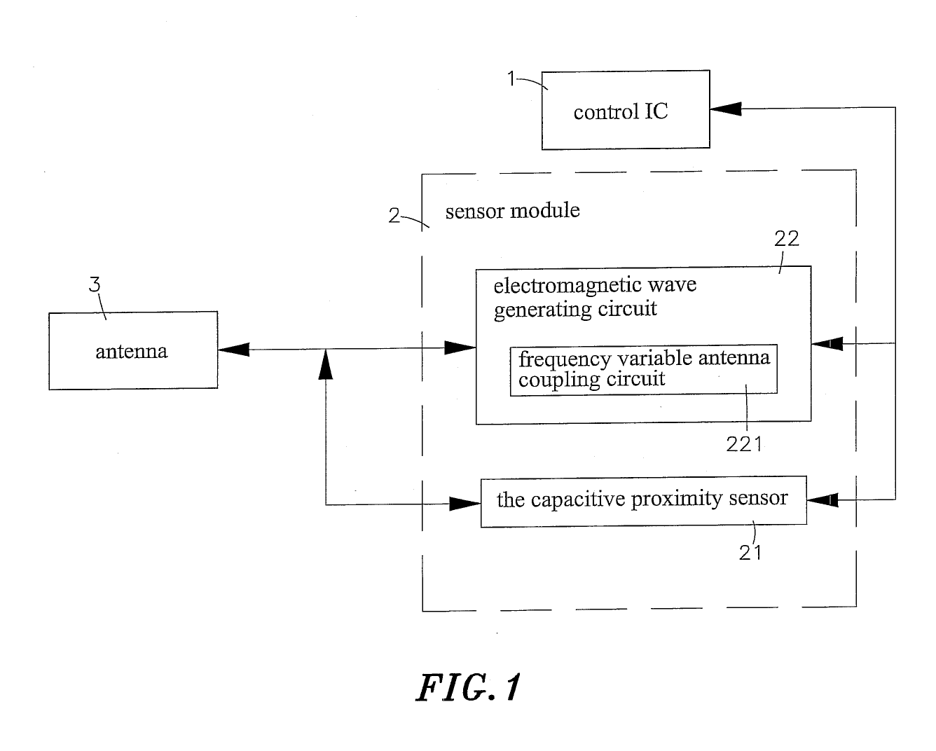

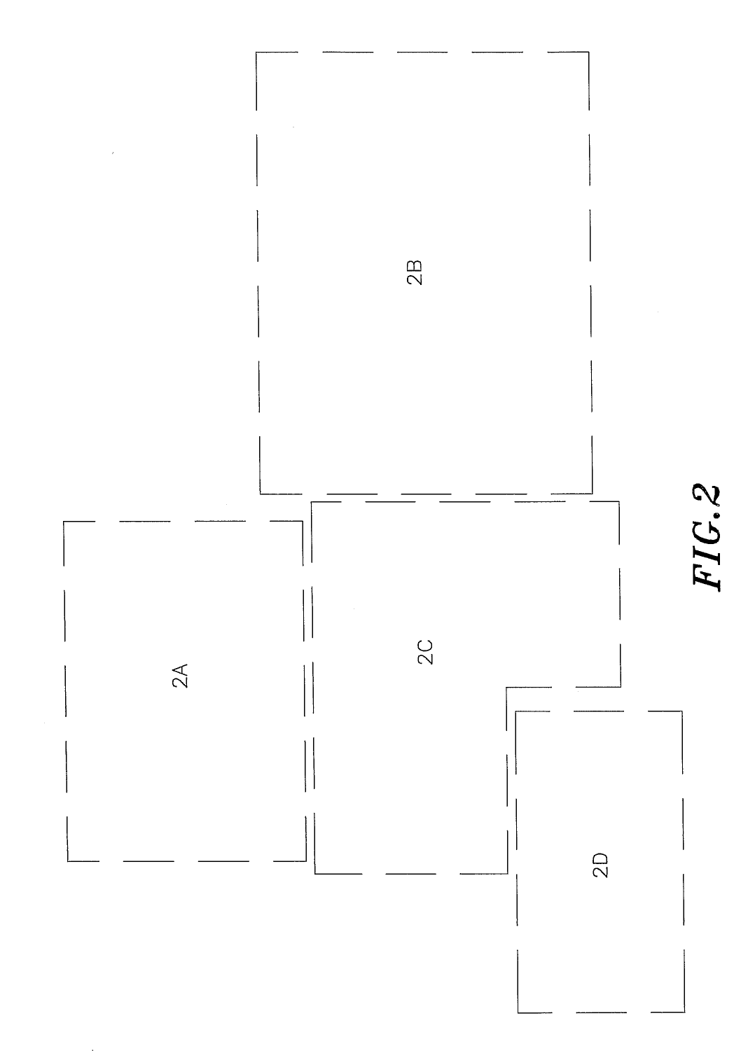

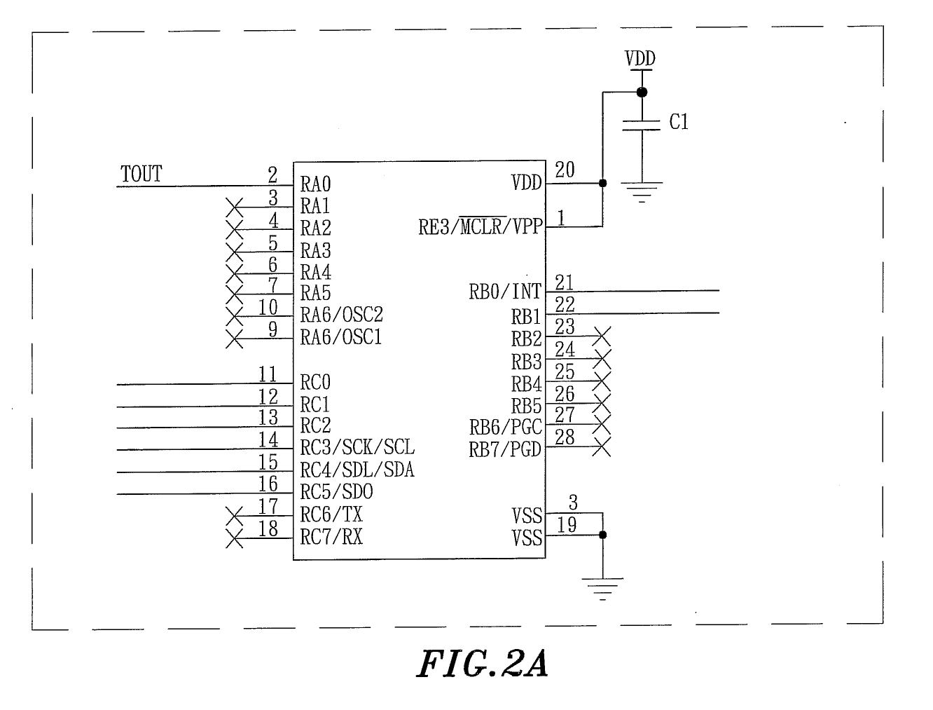

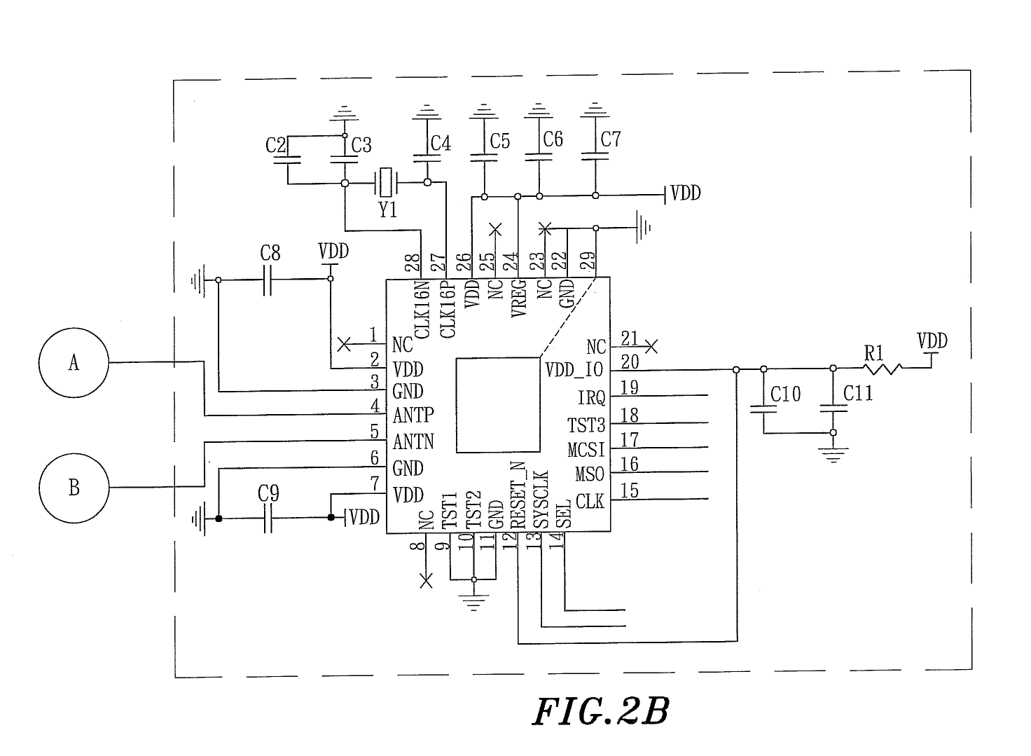

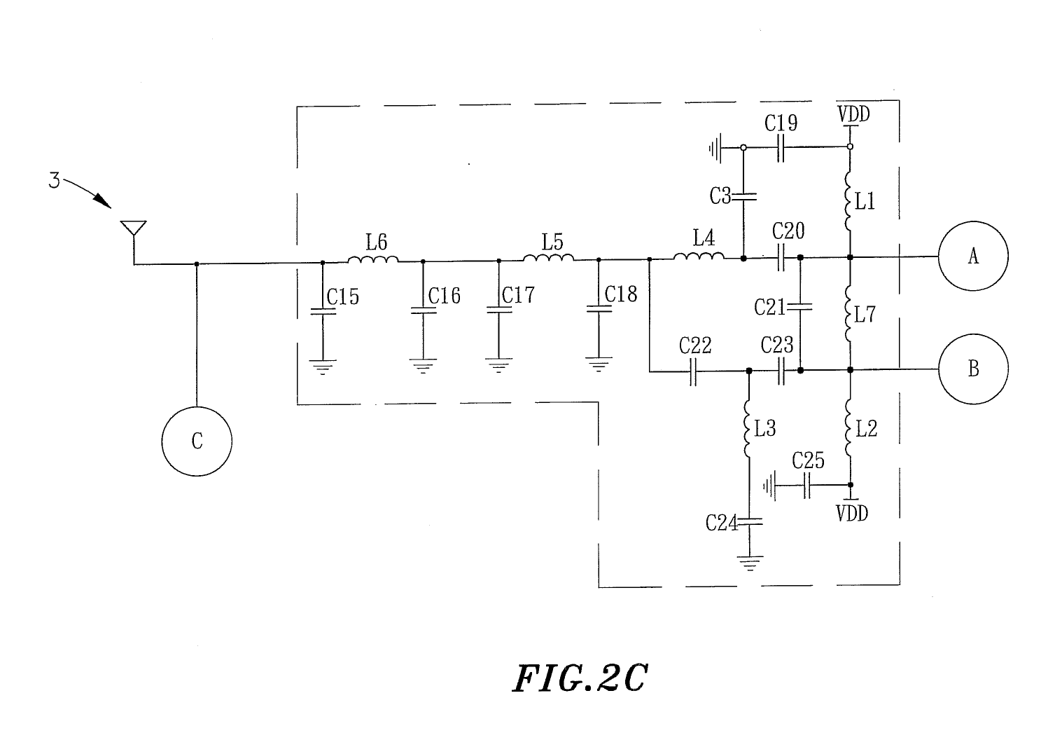

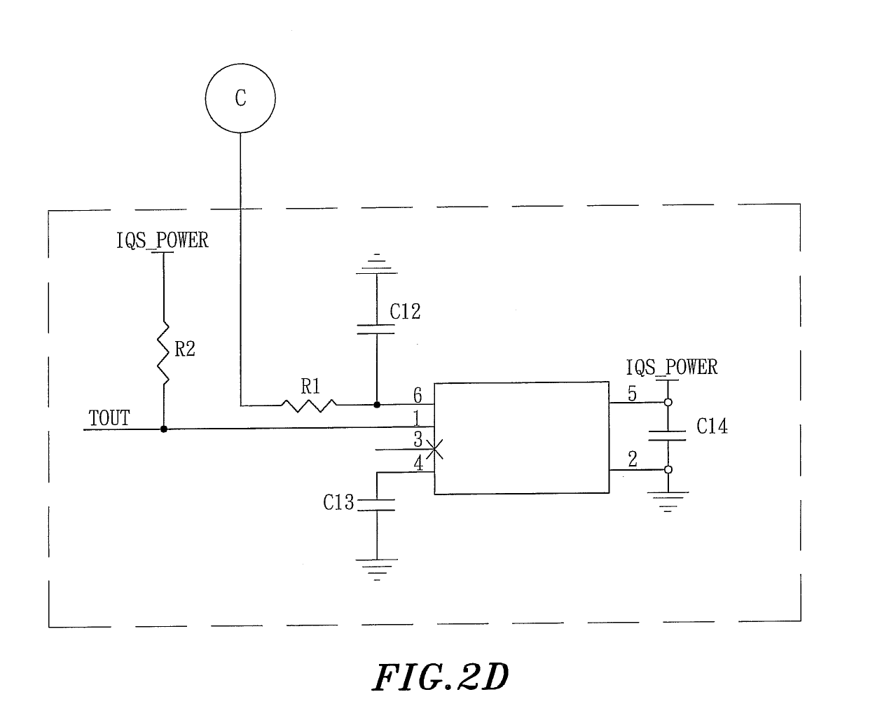

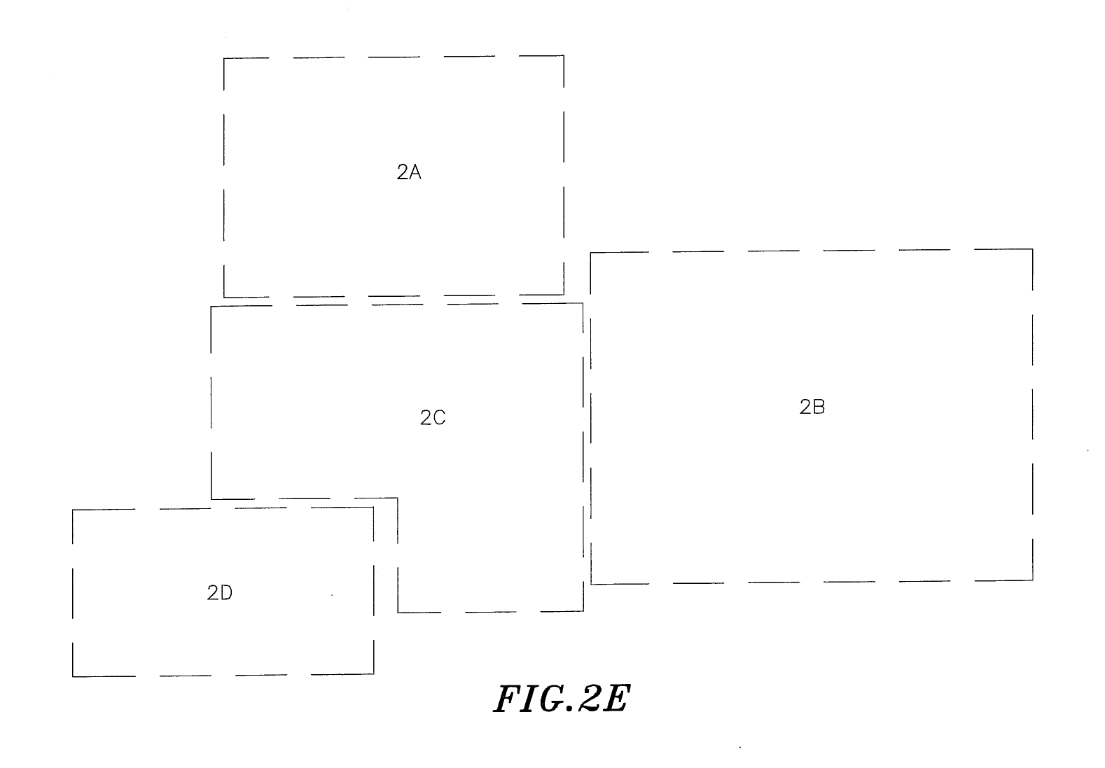

Referring to FIGS. 1, 2, 2A, 2B, 2C, 2D and 2E, a mixed antenna system is shown, comprising a control IC 1, a sensor module 2 and an antenna 3.

The control IC 1 is electrically coupled with the sensor module 2, which is electrically coupled with the antenna 3. The sensor module 2 comprises a capacitive proximity sensor 21 and an electromagnetic wave generating circuit 22. The capacitive proximity sensor 21 and the electromagnetic wave generating circuit 22 are arranged in parallel. Further, the electromagnetic wave generating circuit 22 can may be a RF (radio frequency) circuit, RFID (radio frequency identification) or radio frequency application circuit, having built therein a frequency variable antenna coupling circuit 221. Further, the control IC 1 is electrically connected to an external processing system.

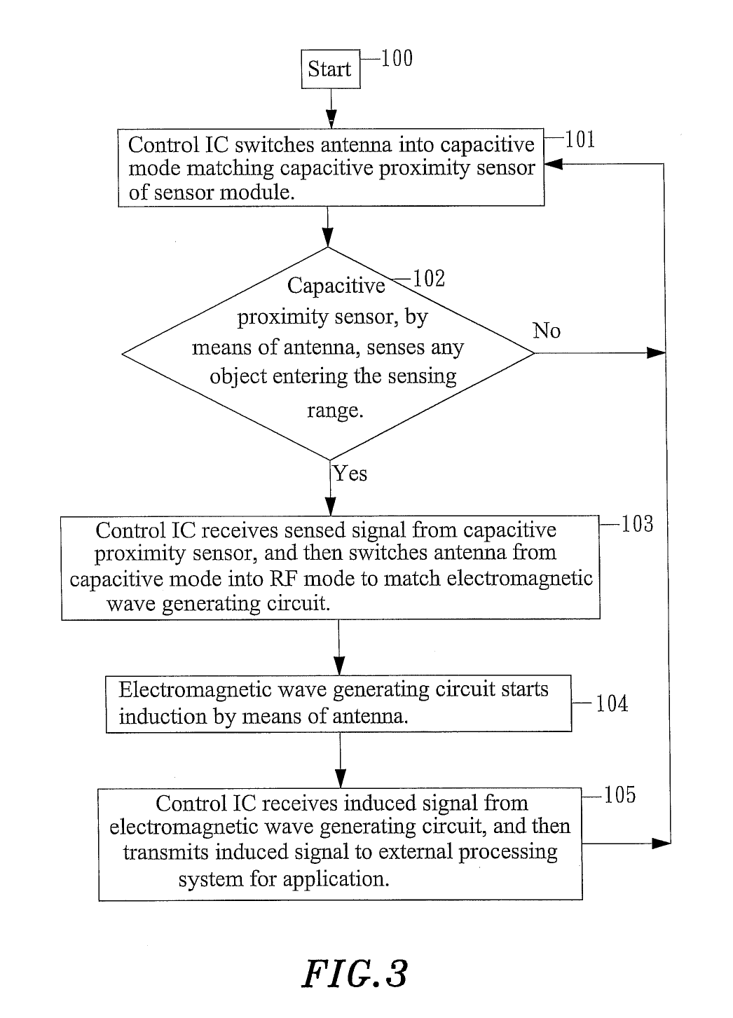

Referring to FIGS. 1 to 3, a method for driving the aforesaid mixed antenna system in accordance with a first embodiment of the present invention includes the steps as follows:
(100) Start;
(101) The control IC 1 switches the antenna 3 into capacitive mode matching the capacitive proximity sensor 21 of the sensor module 2;
(102) The capacitive proximity sensor 21, by means of the antenna 3, senses any object entering the sensing range, and then proceeds to step (103) when there is any approaching objects, or returns to step (101) when there is no approaching object;
(103) The control IC 1 receives the sensed signal from the capacitive proximity sensor 21, and then switches the antenna 3 from capacitive mode into RF mode to match the electromagnetic wave generating circuit 22;
(104) The electromagnetic wave generating circuit 22 starts induction by means of the antenna 3; and
(105) The control IC 1 receives the induced signal from the electromagnetic wave generating circuit 22, and then transmits the induced signal to the external processing system for application, and then returns to step (101).

As stated above, when started, the control IC 1 switches the antenna 3 from an RF mode into a capacitive mode to work as a sensing electrode for the capacitive proximity sensor 21 of the sensor module 2 so that the capacitive proximity sensor 21 can senses any object entering its sensing range. When the capacitive proximity sensor 21 senses a signal, it transmits the sensed signal to the control IC 1. Upon receipt of the sensed signal from the capacitive proximity sensor 21, the control IC 1 switches the antenna 3 from the capacitive mode into the RF mode to match the electromagnetic wave generating circuit 22 so that the electromagnetic wave generating circuit 22 can fetch data signal from the RFID tag of an external object entering its range of induction and transmit the fetched data signal to the control IC 1. Upon receipt of the data signal from the electromagnetic wave generating circuit 22, the control IC 1 transmits the signal to the external processing system for application. Thereafter, the control IC 1 switches the antenna 3 from the RF mode back to the capacitive mode, enabling the capacitive proximity sensor 21 to sense again. Using the capacitive proximity sensor 21 to sense object through the antenna 3, the mixed antenna system consumes less electricity and the antenna 3 produces less amount of heat, and the electromagnetic wave generating circuit 22 works only when an object is approaching. Further, after the external processing system finished processing, the antenna 3 is immediately switched from the RF mode back to the capacitive mode, enabling the capacitive proximity sensor 21 to sense again. Thus, under the same effects of use, the mixed antenna system saves much power consumption and produces less waste heat, achieving the targets of energy-saving and carbon-reduction.

Further, the aforesaid external processing system may be a computer, a server or an industrial computer for the works of inventory recording, inventory counting and supply managing. The external processing system may also handle product delivery checking, and provides a warning signal if the products to be delivered are not in conformity with the delivery list. Actually, the application of the external processing system is not the point to be discussed, and therefore, no further detailed description in this regard is necessary.

Further, the capacitive proximity sensor 21 and the electromagnetic wave generating circuit 22 share the antenna 3. Thus, the invention saves much antenna installation space and avoids interference and assimilation between two antennae. Further, the antenna 3 does not change its matching with the capacitive proximity sensor 21 or the electromagnetic wave generating circuit 22. The antenna 3 can be directly switched between the RF mode and the capacitive mode without making any adjustment. The invention is applicable to any conventional RF type induction system simply by modifying the posterior circuits without changing its original antenna, thereby saving the cost.

Further, the invention may also be used for wireless charging. When an external object approaches the range of induction, the capacitive proximity sensor 21 transmits its sensed signal to the control IC 1. Upon receipt of the signal from the capacitive proximity sensor 21, the control IC 1 switches the antenna 3 to the RF mode of the electromagnetic wave generating circuit 22, enabling the electromagnetic wave generating circuit 22 to be induced by the induction coil of the external object for induction charging. After charging, the control IC 1 switches the antenna 3 from the RF mode of the electromagnetic wave generating circuit 22 back to the capacitive mode of the capacitive proximity sensor 21.

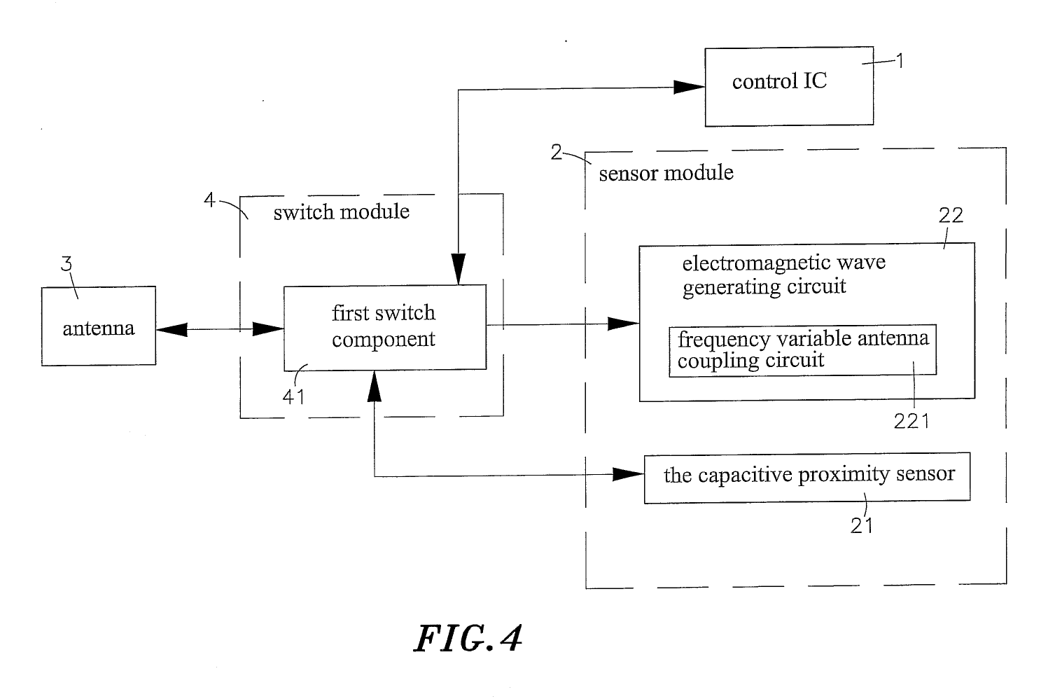

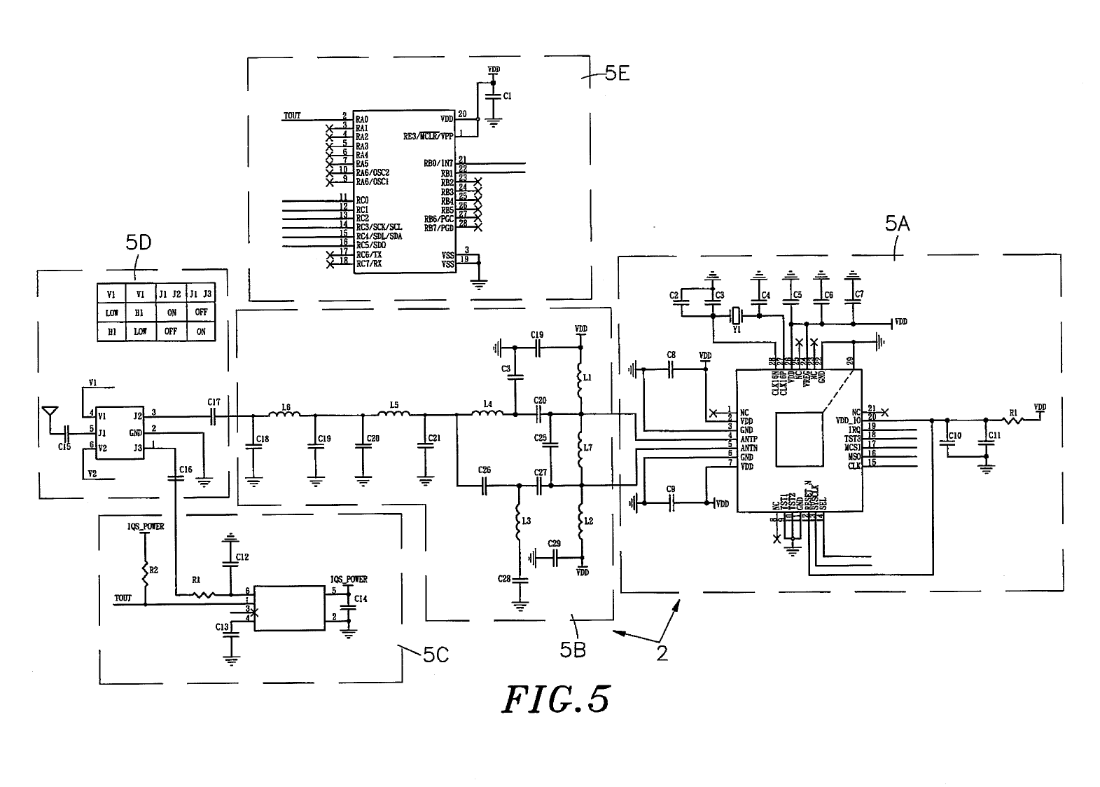

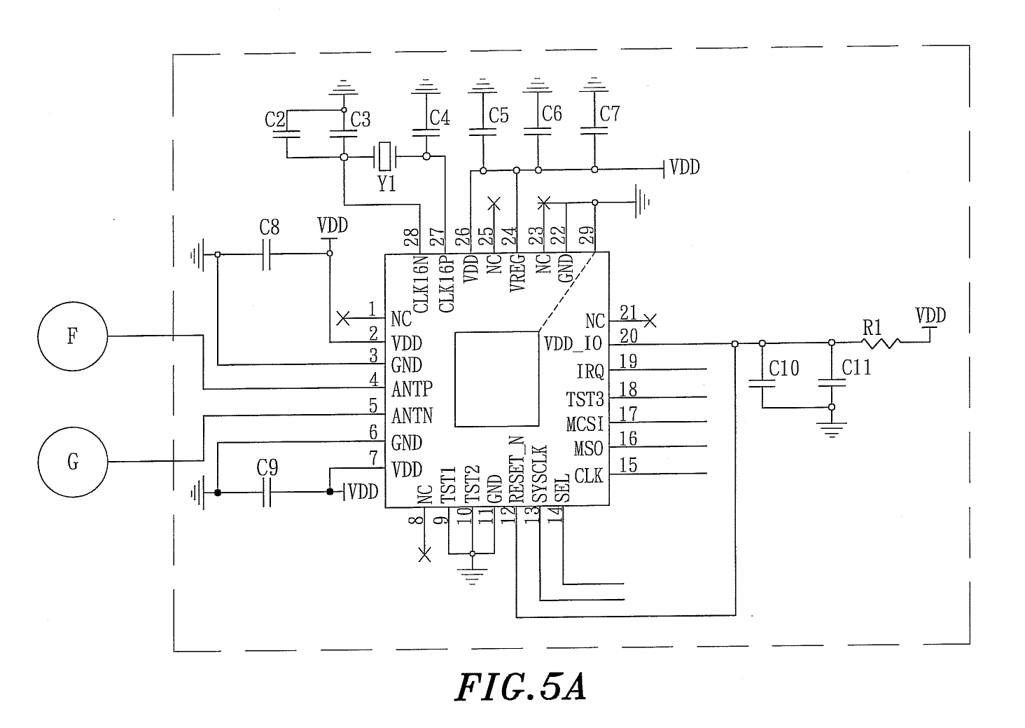

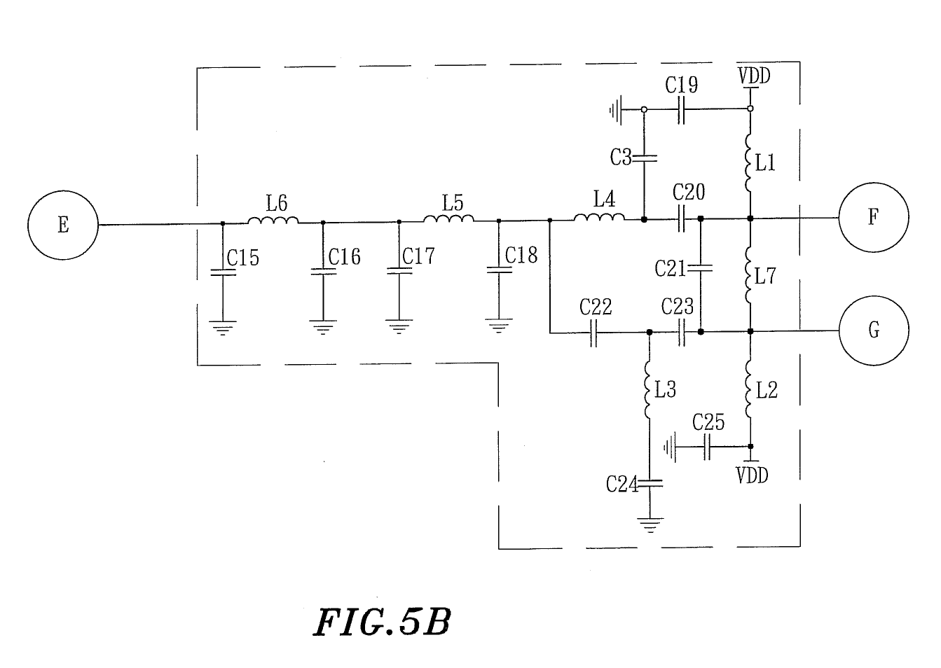

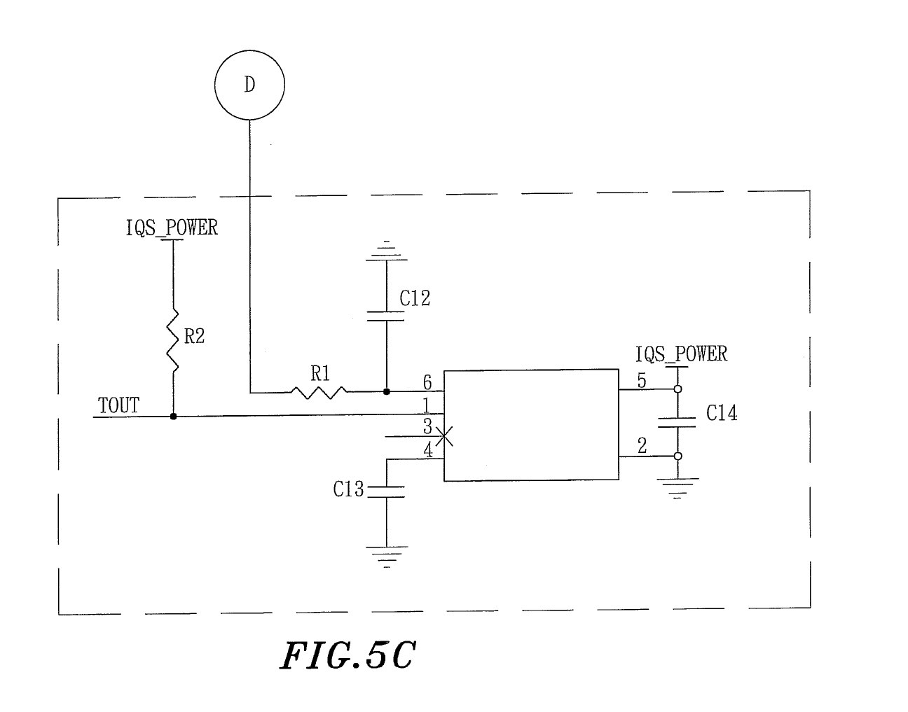

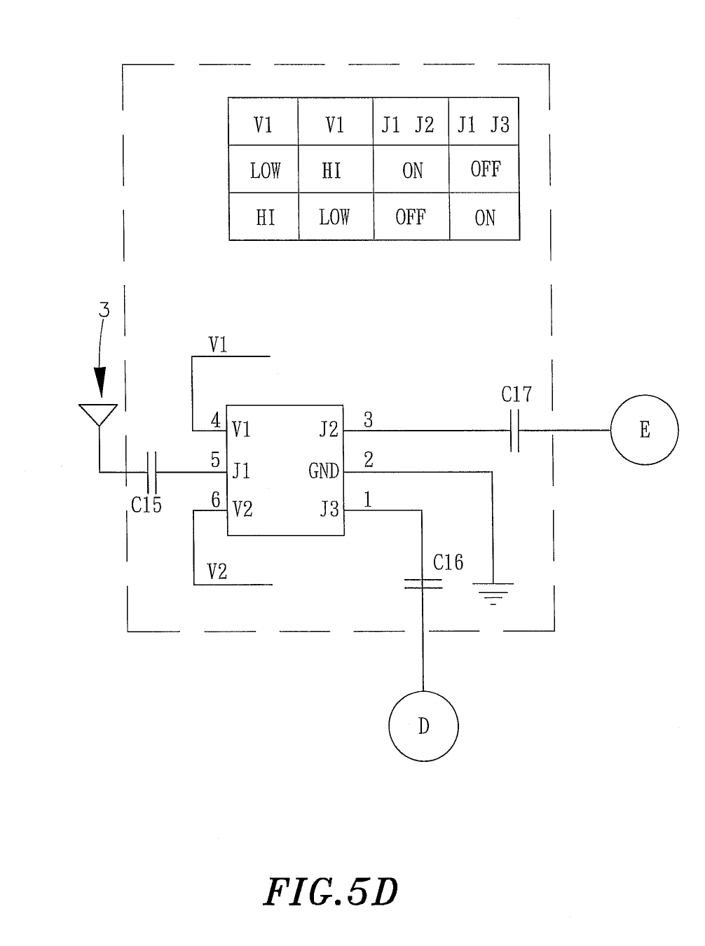

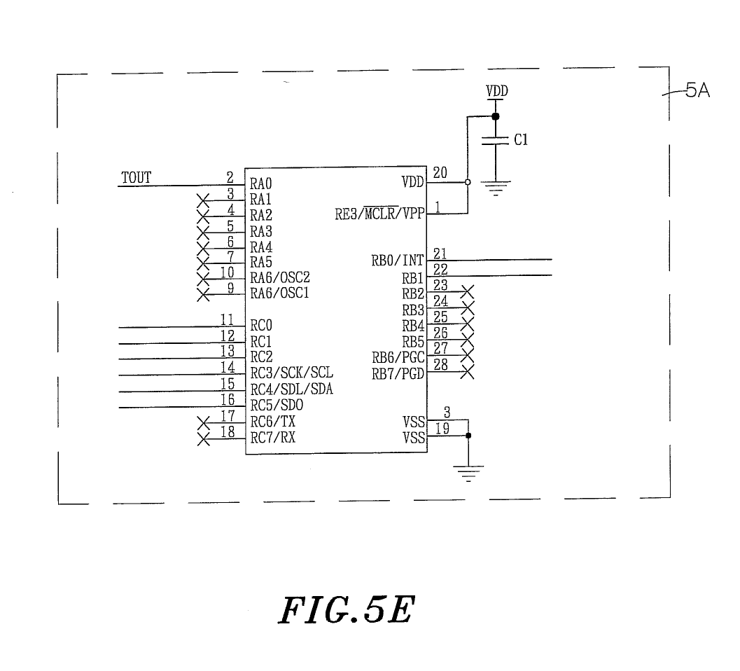

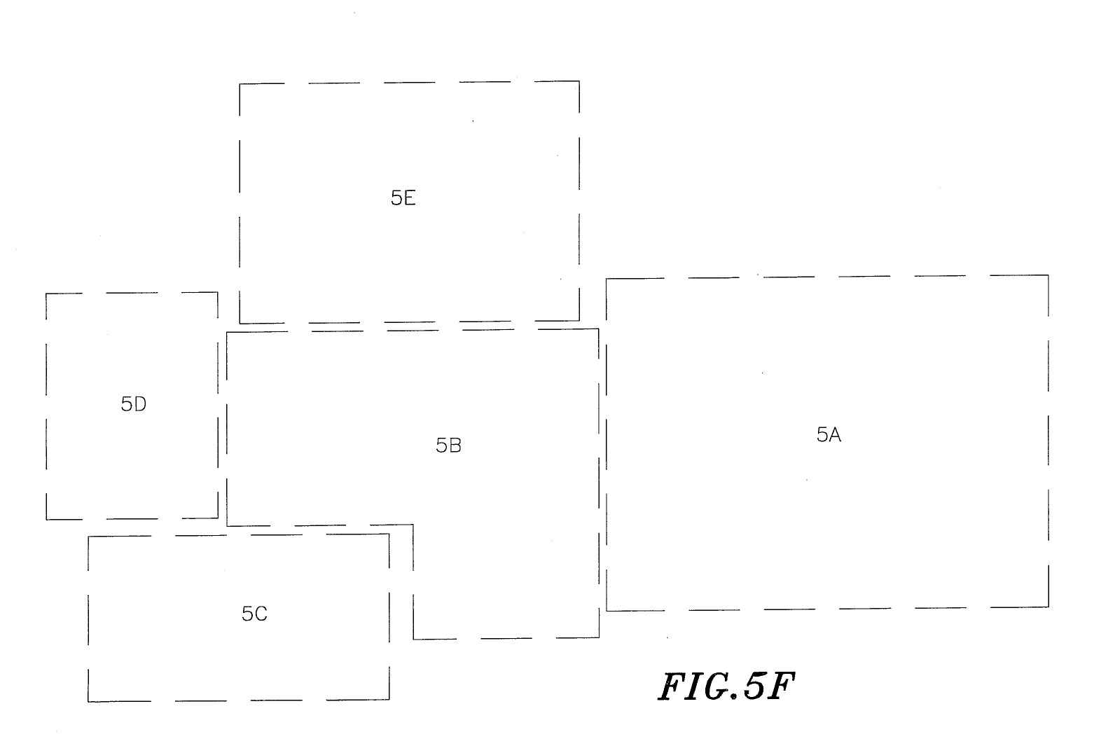

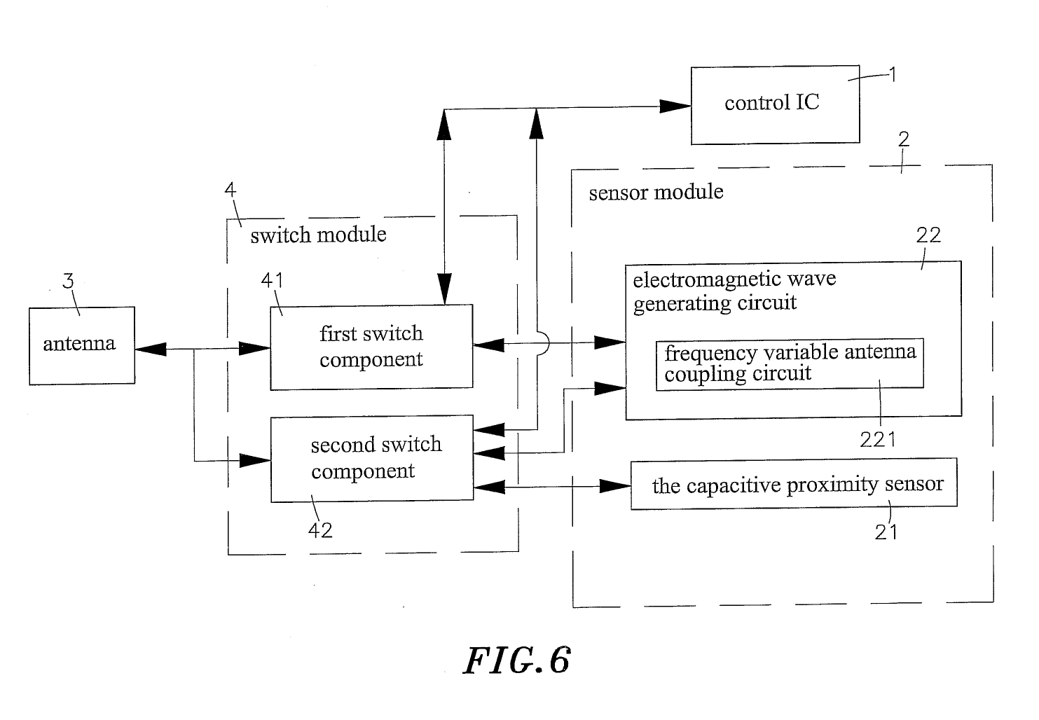

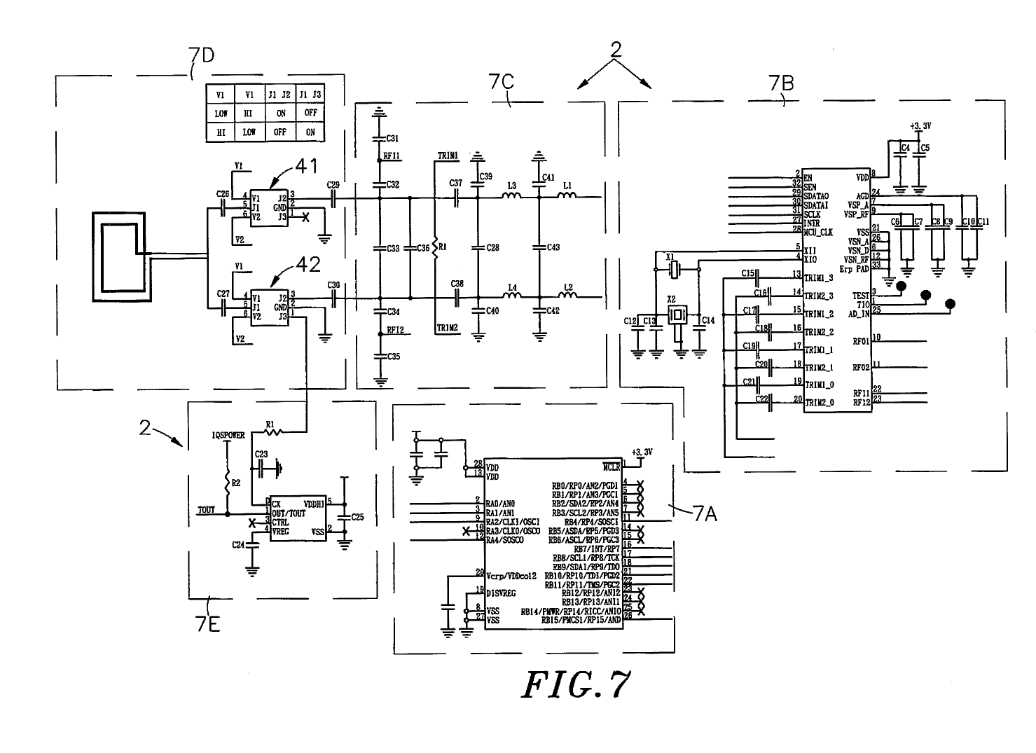

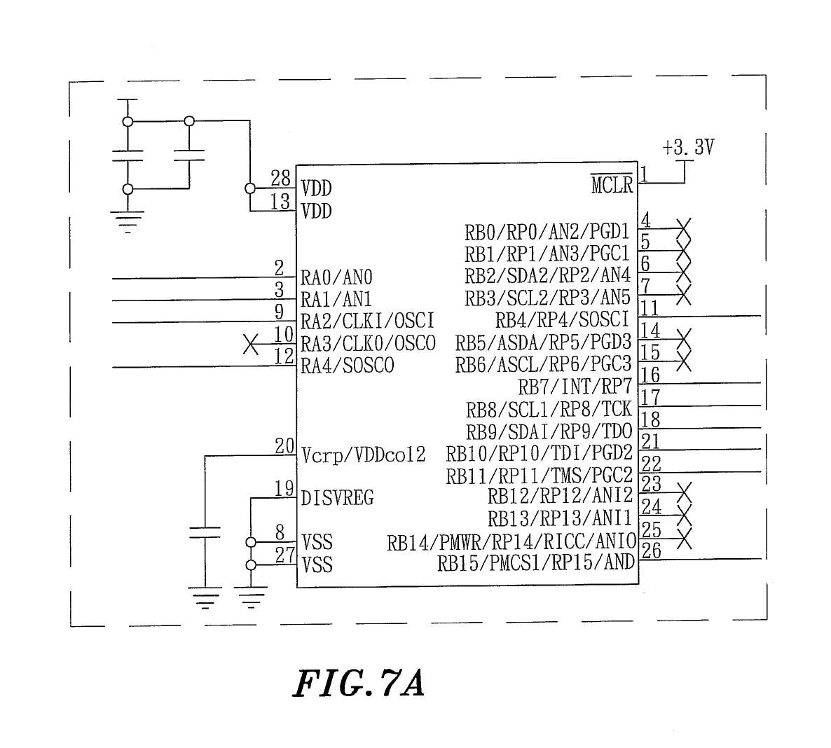

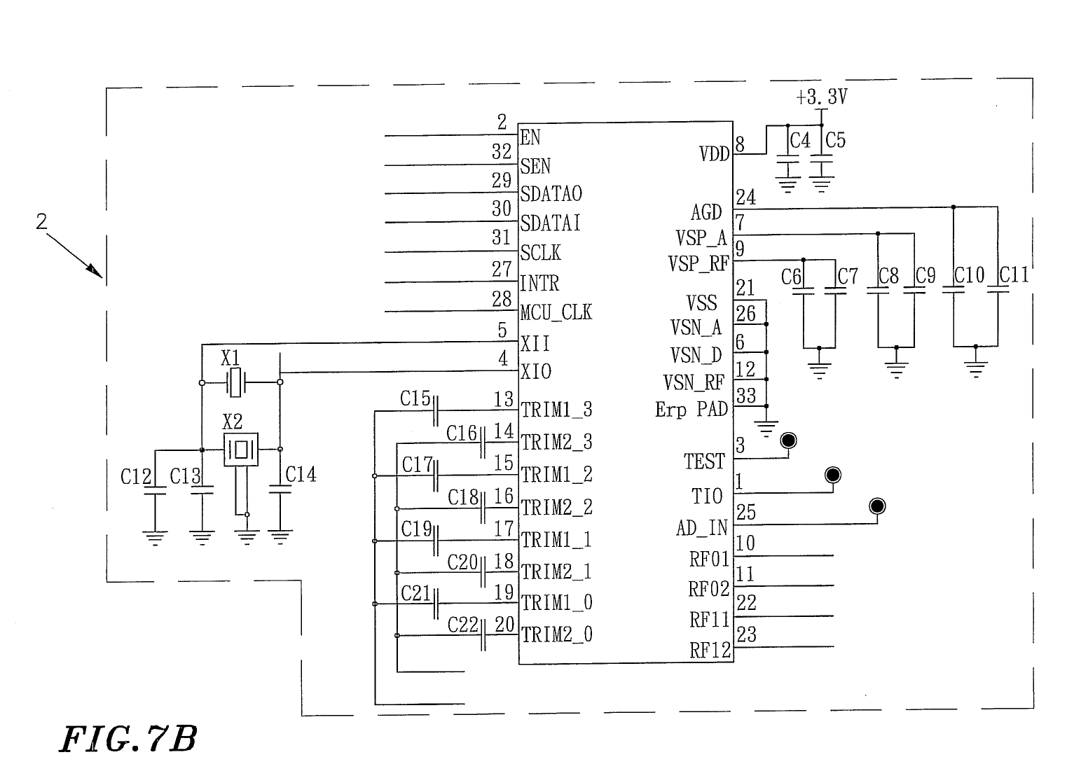

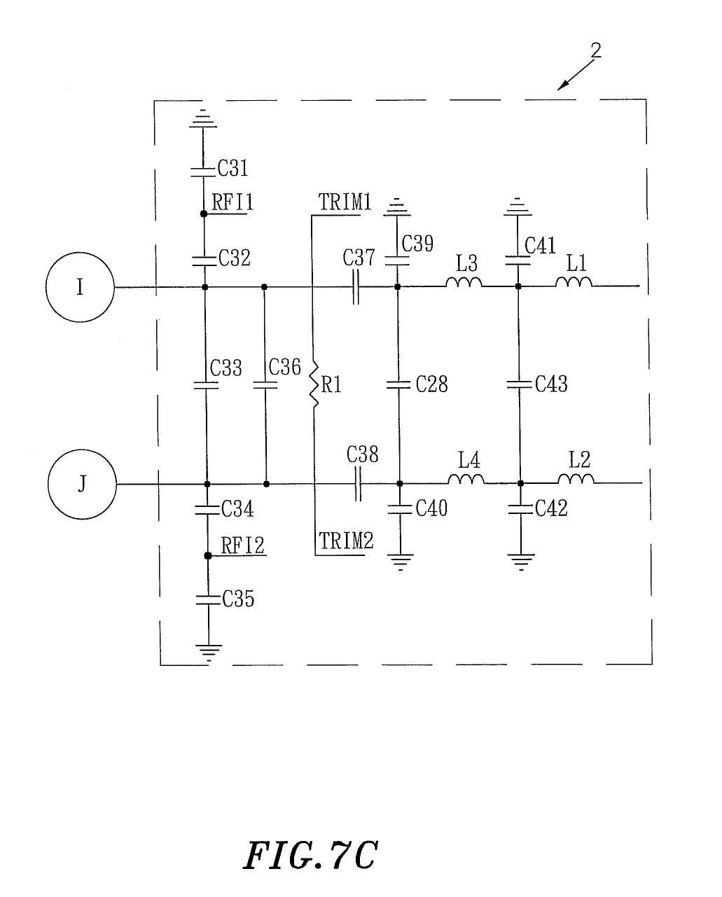

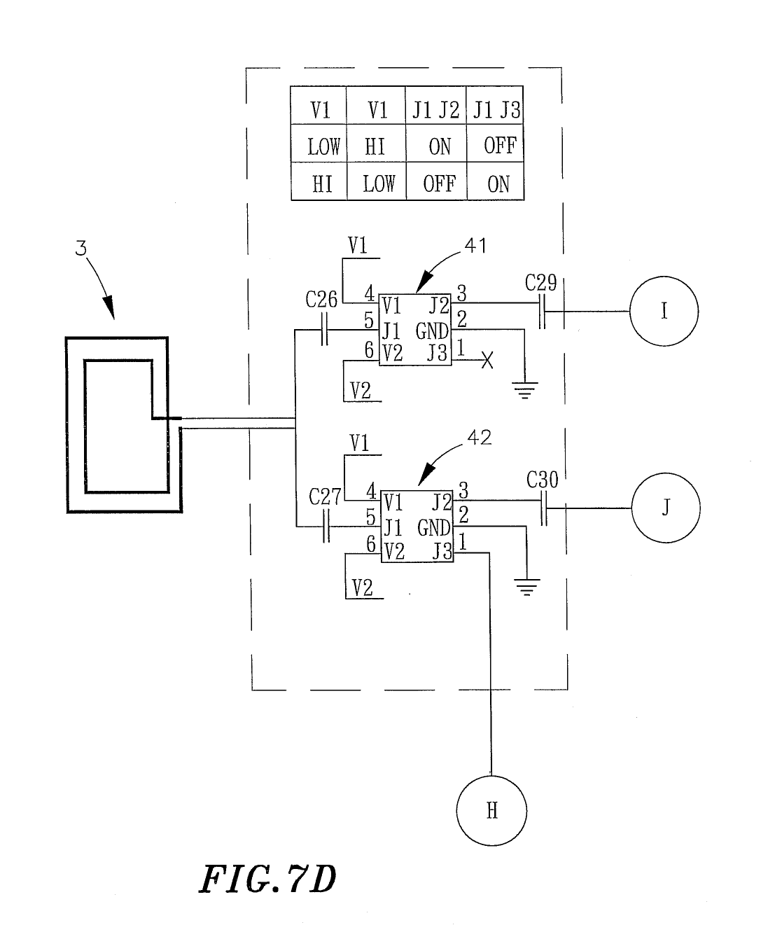

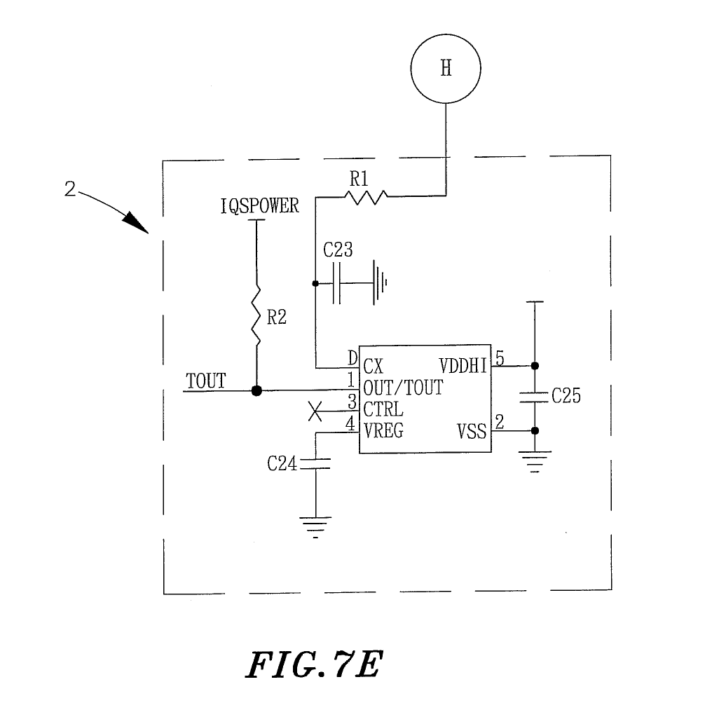

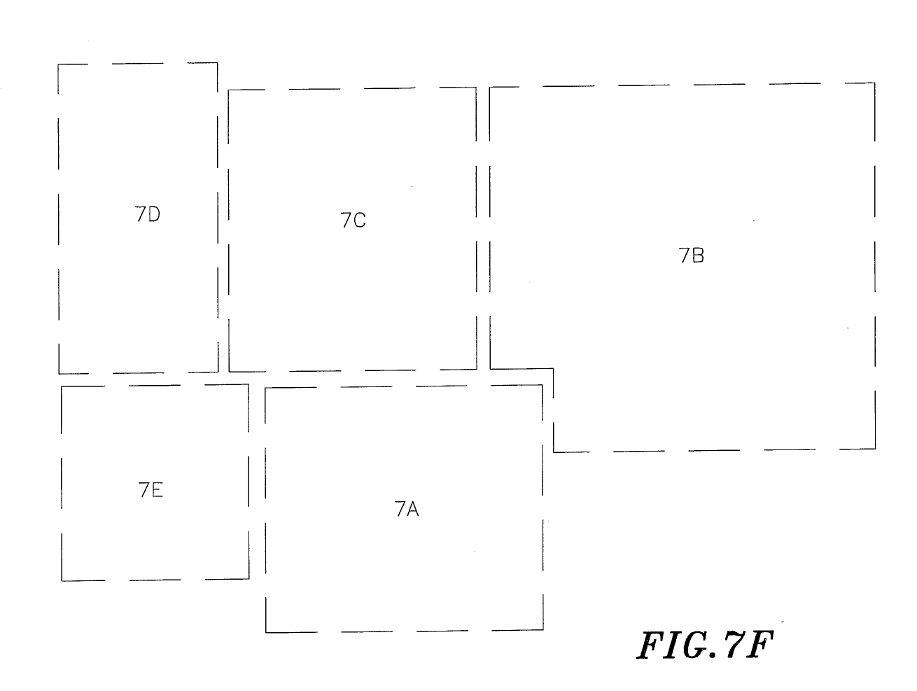

In the arrangement shown in FIGS. 1 and 2, the mixed antenna system comprises a control IC 1, a sensor module 2 consisting of a capacitive proximity sensor 21 and an electromagnetic wave generating circuit 22 that are connected in parallel, and the sensor module 2 is electrically connected in series to the control IC 1 and an antenna 3. By means of time-division multiplexing, the control IC 1 may switch the antenna 3 between the capactive mode to match the capacitive proximity sensor 21 and the RF mode to match the electromagnetic wave generating circuit 22. In a second embodiment of the present invention, as shown in FIGS. 4, 5, 5A-5F, 6, 7 and 7A-7F, the mixed antenna system further comprises a switch module 4. The sensor module 2 is electrically connected with the control IC 1 and the antenna 3. In the embodiment shown in FIG. 4, the switch module 4 comprises a first switch component 41 electrically coupled with the control IC 1, the electromagnetic wave generating circuit 22, the capacitive proximity sensor 21 and the antenna 3. In a third embodiment shown in FIG. 6, the switch module 4 comprises a first switch component 41, which is electrically coupled with the control IC 1 and the electromagnetic wave generating circuit 22 of the sensor module 2, and a second switch component 42 electrically coupled with the control IC 1, the electromagnetic wave generating circuit 22 and the capacitive proximity sensor 21 of the sensor module 2. In either of the above two embodiments, the control IC 1 provides a signal to switch the first switch component 41 and the second switch component 42, enabling the antenna 3 to be electrically connected to the electromagnetic wave generating circuit 22 or the capacitive proximity sensor 21. Thus, the antenna 3 can be selectively used with the electromagnetic wave generating circuit 22 or the capacitive proximity sensor 21 for different applications (electromagnetic wave or capacitive induction).

In conclusion, the invention provides a mixed antenna system driving method for driving a mixed antenna system, having advantages and features as follows:
1. The control IC 1 controls switching between the RF mode for the electromagnetic wave generating circuit 22 and capacitive mode for the capacitive proximity sensor 21 of the sensor module 2, enabling the capacitive proximity sensor 21 of the sensor module 2 to sense the approaching of an external object via the antenna 3 and then enabling the electromagnetic wave generating circuit 22 to start induction operation via the antenna 3 after detection of the presence of the external object by the capacitive proximity sensor 21, i.e., the capacitive proximity sensor 21 performs a long period sensing work with less power consumption and less waste heat production and, the electromagnetic wave generating circuit 22 is controlled to work only upon approaching of an external object. Thus, under the same effects of use, the mixed antenna system saves much power consumption and produces less waste heat, achieving the targets of energy-saving and carbon-reduction.
2. As the control IC 1 controls selective connection between the antenna 3 and the electromagnetic wave generating circuit 22 or the capacitive proximity sensor 21, the capacitive proximity sensor 21 and the electromagnetic wave generating circuit 22 share the common antenna 3, saving product cost and installation space.
3. The capacitive proximity sensor 21 and the electromagnetic wave generating circuit 22 are alternatively connected to the common antenna 3, avoiding antenna interference, destruction in antenna radiation pattern or matching change, assuring a high performance in capacitive induction or RF induction, and eliminating unnecessary adjustment or maintenance works.
4. By means of modifying the posterior circuits, the invention is applicable to any conventional RF type induction system without changing all the components, and therefore the invention can save much the equipment cost.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A mixed antenna system driving method for driving a mixed antenna comprising a control IC electrically connected to an external processing system, a sensor module and an antenna, said sensor module comprising a capacitive proximity sensor and an electromagnetic wave generating circuit selectively connectable to said antenna subject to the control of said control IC, the mixed antenna system driving method comprising the steps of:
(A) start;
(B) said control IC switches said antenna into a capacitive mode matching said capacitive proximity sensor of said sensor module;
(C) said capacitive proximity sensor senses the approaching of an external object by means of said antenna, and then proceeds to step (D) when positive, or returns to step (A) when negative;
(D) said control IC receives a sensed signal from said capacitive proximity sensor, and then switches said antenna from said capacitive mode into a RF mode to match said electromagnetic wave generating circuit;
(E) said electromagnetic wave generating circuit starts induction by means of said antenna; and
(F) said control IC receives an induced signal from said electromagnetic wave generating circuit, and then transmits the induced signal to said external processing system for application, and then returns to step (B).

2. The mixed antenna system driving method as claimed in claim 1, wherein said sensor module is electrically connected with said control IC and said antenna in series; said capacitive proximity sensor and said electromagnetic wave generating circuit of said sensor module are electrically connected in parallel; said electromagnetic wave generating circuit is a radio frequency circuit comprising a frequency variable antenna coupling circuit.

3. The mixed antenna system driving method as claimed in claim 1, wherein said radio frequency circuit of said electromagnetic wave generating circuit is configured subject to one of RFID (radio frequency identification) or radio frequency application protocols.

4. The mixed antenna system driving method as claimed in claim 1, wherein said mixed antenna system further comprises a switch module switchable for enabling said sensor module to be electrically coupled with said control IC and said antenna; said capacitive proximity sensor and said electromagnetic wave generating circuit of said sensor module are electrically connected in parallel; said electromagnetic wave generating circuit is a radio frequency circuit comprising a frequency variable antenna coupling circuit.

5. The mixed antenna system driving method as claimed in claim 4, wherein said switch module comprises a first switch component electrically coupled with said control IC, said electromagnetic wave generating circuit, said capacitive proximity sensor and said antenna.

6. The mixed antenna system driving method as claimed in claim 4, wherein said switch module comprises a first switch component electrically coupled with said control IC and said electromagnetic wave generating circuit of said sensor module, and a second switch component electrically coupled with said control IC, said electromagnetic wave generating circuit and said capacitive proximity sensor of said sensor module.

7. The mixed antenna system driving method as claimed in claim 4, wherein said radio frequency circuit of said electromagnetic wave generating circuit is configured subject to one of RFID (radio frequency identification) or radio frequency application protocols.
